(19) United States
(12) Patent Application Publication
(10) Pub. No.: US 2025/0369407 A1
(43) Pub. Date: Dec. 4, 2025

(54) APPARATUS FOR EXHAUST GAS RECIRCULATION AND A METHOD FOR PREVENTING ICE FORMATION IN SUCH AN APPARATUS

(71) Applicant: DAIMLER TRUCK AG, Leinfelden-Echterdingen (DE)

(72) Inventor: Moritz SCHUMACHER, Schorndorf (DE)

(21) Appl. No.: 19/219,339

(22) Filed: May 27, 2025

(30) Foreign Application Priority Data
May 28, 2024 (DE) 10 2024 114 889.6

(51) Int. Cl. F02M 26/33; F02M 26/16; F02M 26/23; F02M 26/35

(52) U.S. Cl. CPC F02M 26/33; F02M 26/16; F02M 26/23; F02M 26/35

(57) ABSTRACT

An apparatus recirculates exhaust gas for an internal combustion engine. The apparatus includes an exhaust gas recirculation line, which has an exhaust gas recirculation cooler, an exhaust gas recirculation valve, and a catalyst. The is arranged after the exhaust gas recirculation cooler in the flow direction of the recirculated exhaust gas. A defined fuel concentration in the exhaust gas can be set via special control of combustion and/or ignition, which is then converted in the catalyst producing heat.

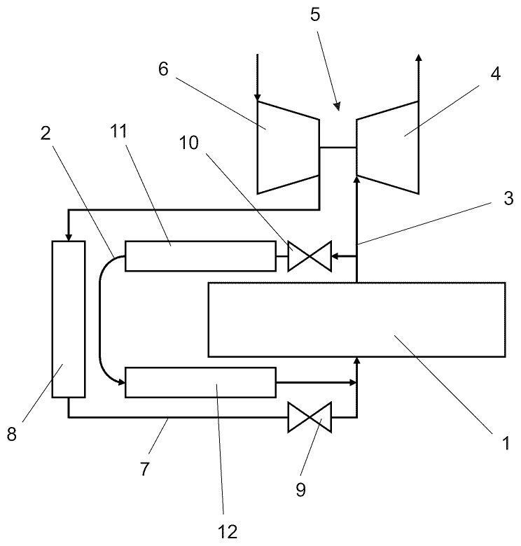

### CROSS-REFERENCE TO RELATED APPLICATIONS

This application claims priority under 35 U.S.C. § 119 to German patent application DE 10 2024 114 889.6, filed May 28, 2024, the entire content of which is herein expressly incorporated by reference.

### BACKGROUND AND SUMMARY OF THE INVENTION

Exemplary embodiments of the invention relate to an apparatus for exhaust gas recirculation for an internal combustion engine, in particular a gas engine, as well as to a method for preventing ice formation in such an apparatus.

The application of exhaust gas recirculation lines in internal combustion engines is generally already known from the prior art. In order to improve combustion and raw emissions, under specific operating conditions, a part of the exhaust gas can be recirculated, for example via an exhaust gas recirculation line into an air supply duct to the internal combustion engine. In this context, reference can be made to US 2012/0055156 A1 as an example. This shows such a construction, in which the exhaust gas recirculation line branches off from an exhaust gas line of the internal combustion engine before a turbine. The exhaust gas flows through initially into a catalyst, in order to reduce nitrogen oxides, a sensor, an exhaust gas recirculation cooler, and then set in its amount by an exhaust gas recirculation valve, the supply air is fed to the internal combustion engine after a compressor and a charge air cooler.

JP 2020-033974 A also shows a similar construction with a NOx catalyst.

The catalysts described in this step serve to purify the exhaust gas and are arranged before the exhaust gas recirculation cooler and the exhaust gas recirculation valve in the flow direction, in order to reduce the contamination of this component accordingly.

In gas engines, and here in particular in hydrogen engines, the exhaust gases have a very high water content of up to 30%. Here, the exhaust gas recirculation valve is typically designed so that it always allows a certain amount of leakage, in order to be able to set the exhaust gas at different temperatures and under different conditions. However, this leakage is difficult at cold temperatures and at a high water content level in the recirculated exhaust gas because it can become condensation and form ice when it comes into contact with the cold intake air. This means that a throttle valve can be blocked for example, or the flow cross-section for the inflowing air and/or the recirculated exhaust gas is narrowed so far that any significant operation of the internal combustion engine is not possible anymore.

In order to avoid the problem of freezing water in the exhaust gas recirculation line and the region of the intake system, after the exhaust gas has been recirculated, an exhaust gas recirculation valve can be used, for example, which closes in a completely sealed manner. The usage of the exhaust gas recirculation line can be completely prevented at very low ambient temperatures due to such a reduction in leakage. However, this has corresponding disadvantages, as such exhaust gas recirculation valves are relatively expensive and tend to break down relatively quickly with respect to possible contamination in the exhaust system.

A further known alternative here is electric heating of the related components, which is accordingly complex and energy intensive, or heating via a coolant of the internal combustion engine, which is still unfavorable with respect to complexity, as corresponding valves have to be provided and fluid lines have to be introduced and in turn led away. Furthermore, complex heat exchangers are necessary.

Exemplary embodiments of the present invention are directed to an improved apparatus for recirculating exhaust gas, in particular for internal combustion engines operated with hydrogen, which simply and efficiently reduces the problem of freezing.

The apparatus according to the invention provides an exhaust gas recirculation line, which has, comparably to the prior art, an exhaust gas recirculation valve, an exhaust gas recirculation cooler, and a catalyst.

According to the invention, this catalyst is arranged after the exhaust gas recirculation cooler in the flow direction of the exhaust gas, unlike the prior art. It has a platinum metal (also known as Platinoids, Platinum Group Metal (PGM), Pt, Ir, Os, Pd, Rh, Ru) or a combination of several platinum metals, which for example, are applied as a coating onto metallic or ceramic carriers or can be stored in the catalyst in the form of pellets or coated ceramic pellets. Fuel, and here in particular only hydrogen, which reaches the catalyst, is able to be catalytically oxidized in this catalyst; in particular very low temperatures of around 25° C. are sufficient for hydrogen to enable catalytic conversion. In this manner, a sufficient amount of heat can be supplied to the exhaust gas recirculation line and then subsequently the intake system of the internal combustion engine, in order to reliably prevent icing at low ambient temperatures. The construction is extremely simple and efficient. It does not require any electrical heating elements or similar and further allows the application of an exhaust gas recirculation valve in a conventional construction, which also inherently allows for certain leakage rates.

As already explained, the internal combustion engine is preferably designed as a gas engine, in particular as a hydrogen engine.

According to a very advantageous further development of the apparatus according to the invention, the exhaust gas recirculation line can branch off from an exhaust gas line of the internal combustion engine before a turbine and can open into the air supply duct to the internal combustion engine after a compressor. Here, this is a so-called high-pressure exhaust gas recirculation, which works at the pressure level between the compressor and a turbine of a turbocharger provided here.

In particular, a charge air cooler and a throttle valve can be arranged between the compressor and the opening of the exhaust gas recirculation line, such that the regular inflow air is conveyed via the compressor, sent through the charge air cooler, and then dosed via the throttle valve into the internal combustion engine. The recirculated exhaust gas then enters the supply air in the flow direction of the supply air after this throttle valve.

The exhaust gas recirculation valve can now in principle be arranged before or after the exhaust gas recirculation cooler. According to a very advantageous embodiment, it is arranged between the exhaust gas recirculation cooler and the branch of the exhaust gas recirculation line from the exhaust gas line. The exhaust gas recirculation valve is the first component inside the exhaust gas recirculation line.

The method according to the invention for preventing ice formation in such an apparatus is designed in such a way that control of combustion and/or ignition takes place in the internal combustion engine in such a way that a defined amount of fuel, in particular a defined amount of hydrogen, is adjusted to the catalyst. The hydrogen reaches the catalyst uncombusted by the internal combustion engine. There, it is catalytically converted or combusted, in order to prevent ice formation due to combustion heat.

Further advantageous embodiments of the invention result from the exemplary embodiment which is described in more detail below with reference to the figure.

### BRIEF DESCRIPTION OF THE SOLE DRAWING FIGURE

The sole drawing figure is a schematic representation of an internal combustion engine and an apparatus for exhaust gas recirculation.

### DETAILED DESCRIPTION

The core of the schematic representation of the sole figure forms an internal combustion engine, labelled with 1, which in particular is to be designed as a hydrogen engine. This internal combustion engine 1 now has an apparatus for exhaust gas recirculation having an exhaust gas recirculation line 2, which branches off from an exhaust gas line 3 of the internal combustion engine 1 before a turbine 4 of a turbocharger 5 in the flow direction. In this turbocharger 5, the turbine 4 drives a compressor 6, which conveys compressed supply air to the internal combustion engine 1 via an air supply duct 7. In this air supply duct 7, a charge air cooler 8 and a throttle valve 9 are arranged in a known way and manner.

The exhaust gas recirculation line 2 branches off from the exhaust gas line 3 before the turbine 4 and opens into the air supply duct 7 after the compressor 6. Thus, it is a so-called high-pressure exhaust gas recirculation.

An exhaust gas recirculation valve 10 and an exhaust gas recirculation cooler 11 are arranged inside the exhaust gas recirculation line 2 in a known way and manner. A catalyst, labelled here with 12, follows this exhaust gas recirculation cooler 11 in the flow direction, before the exhaust gas recirculation line 2 opens into the air supply duct 7. This catalyst 12 has a platinum metal (also known as Platinoids, Platinum Group Metal (PGM), Pt, Ir, Os, Pd, Rh, Ru) or a combination of several platinum metals, which for example, are applied as a coating onto metallic or ceramic carriers and, due to its particular characteristics, can be catalytically combusted at very low temperatures at around 25° C. There is also the danger that ice formation could occur in the exhaust gas recirculation line 2 and/or the supply 7, after the exhaust gas recirculation line 2 has opened into this, then combustion and/or ignition can be controlled by control of the internal combustion engine 1, not shown here, so that a defined amount of hydrogen flows out uncombusted from the internal combustion engine 1, is recirculated through the exhaust gas recirculation line 2 and can be combusted accordingly in the catalyst 12.

The control, which in particular is a part of the already required engine control, can be used in order to achieve a target heat input in the region of the catalyst 12, and so icing of the exhaust gas recirculation line 2 or the air supply duct 7, after the exhaust gas recirculation line 2 has opened into it, is reliably prevented with chemical energy alone from the fuel. The entire construction is therefore purely passive and does not require any additional valves, electrical switching elements, electrical lines, fluid lines or similar.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

What is claimed is:

1. An apparatus configured to recirculate internal combustion engine exhaust gas recirculation, the apparatus comprising:
an exhaust gas recirculation line having an exhaust gas recirculation cooler, an exhaust gas recirculation valve, and a catalyst,
wherein the catalyst is arranged after the exhaust gas recirculation cooler in a flow direction of recirculated exhaust gas.

2. The apparatus of claim 1, wherein the internal combustion engine is designed a hydrogen engine.

3. The apparatus of claim 1, wherein the exhaust gas recirculation line branches off from an exhaust gas line of the internal combustion engine before a turbine and opens into an air supply duct to the internal combustion engine after a compressor.

4. The apparatus of claim 3, further comprising:
a charge air cooler and a throttle valve arranged in the air supply duct between the compressor and the opening of the exhaust gas recirculation line.

5. The apparatus of claim 3, wherein the exhaust gas recirculation valve is arranged between the exhaust gas recirculation cooler and the branch of the exhaust gas recirculation line from the exhaust gas line.

6. A method for preventing ice formation in an apparatus configured to recirculate internal combustion engine exhaust gas recirculation, the apparatus comprising an exhaust gas recirculation line having an exhaust gas recirculation cooler, an exhaust gas recirculation valve, and a catalyst, wherein the catalyst is arranged after the exhaust gas recirculation cooler in a flow direction of recirculated exhaust gas, the method comprising:
adjusting a defined uncombusted amount of fuel at the catalyst by controlling the combustion or ignition in the internal combustion engine, wherein the defined uncombusted amount of fuel is catalytically burned by the catalyst to avoid ice formation due to combustion heat.
